(19) United States
(12) Patent Application Publication
(10) Pub. No.: US 2007/0142594 A1
(43) Pub. Date: Jun. 21, 2007

(54) Horizontal boiling plug flow reactor

(75) Inventors: Doug Berti, Houston, TX (US); Thanh Nguyen, Sugar Land, TX (US); Philippe Tanguy, Outremont (CA); Marie-Noelle Moutaillier, Maxilly (FR); Jay Reimers, Houston, TX (US)

Correspondence Address: FINA TECHNOLOGY INC, PO BOX 674412, HOUSTON, TX, 77267-4412, US

(73) Assignee: Fina Technology, Inc.

(21) Appl. No.: 11/384,596

(22) Filed: Mar. 20, 2006

Related U.S. Application Data
(60) Provisional application No. 60/752,766, filed on Dec. 21, 2005.

(51) Int. Cl. C08F 136/00

(52) U.S. Cl. 526/335; 526/346

(57) ABSTRACT

A method for removing heat from a horizontal linear flow reactor, comprising introducing vapor bubbles into a liquid medium in the reactor and removing the vapor from the reactor. A method of producing an elastomer reinforced polymer comprising autorefrigerating the reactants in a horizontal linear flow reactor in which both initial polymerization and phase inversion occur. A method of removing heat from a horizontal plug flow reactor comprising aerating the reactants within the reactor, wherein the aeration promotes radial mixing of the reactants but does not substantially promote axial mixing of the reactants. A horizontal linear flow reactor, comprising a horizontal reaction chamber having one or more mechanical flow facilitators disposed therein and a sparger attached to the bottom of at least a portion of the reaction chamber.

### CROSS-REFERENCE TO RELATED APPLICATIONS

The present application claims priority to U.S. Provisional Application No. 60/752,766 filed Dec. 21, 2005 and entitled “Horizontal Boiling Plug Flow Reactor and Reactor System for the Production of High Impact Polystyrene,” which is incorporated by reference. The present application relates to commonly owned U.S. patent application Ser. No. 11/121,795 filed May 4, 2005 and entitled “Reactor Apparatus Having Reduced Back Mixing” and U.S. patent application Ser. No. [Atty. Docket No. COS-1037 (4176-00801)] filed concurrently herewith and entitled “Reactor System For The Production Of High Impact Polystyrene,” which are incorporated by reference herein.

### STATEMENT REGARDING FEDERALLY SPONSORED RESEARCH OR DEVELOPMENT

Not applicable.

### FIELD OF THE INVENTION

This disclosure relates to reactor design. More specifically, this disclosure relates to heat removal in linear flow reactors, for example plug flow polymerization reactors for the production of high impact polystyrene.

### BACKGROUND OF THE INVENTION

Elastomer-reinforced polymers of monovinylidene aromatic compounds such as styrene, alpha-methylstyrene and ring-substituted styrene have found widespread commercial use. For example, elastomer-reinforced styrene polymers having discrete elastomer particles such as cross-linked rubber dispersed throughout the styrene polymer matrix can be useful for a range of applications including food packaging, office supplies, point-of-purchase signs and displays, houseware and consumer goods, building insulation and cosmetics packaging. Such elastomer-reinforced polymers are commonly referred to as high impact polystyrene (HIPS).

Methods for the production of polymers, such as HIPS, typically employ polymerization using a continuous flow process. Continuous flow processes involve apparatuses comprising a plurality of serially arranged reactors wherein the degree of polymerization increases from one reactor to the next. The reactors themselves can be continuously stirred tank reactors (CSTR) and/or plug flow reactors (PFR). Polymerization reactions are highly exothermic thus means are required to control the temperature in the reactors as the polymerization proceeds. The removal of the heat generated during the reaction is an important factor in the overall reaction and manufacturing efficiency. The design of PFRs does not allow for easy temperature control where there is excessive heat output, a problem that may be particularly noticeable in wide reactors, for example tubular reactors having a diameter of greater than about 15 cm.

Thus it would be desirable to develop a PFR apparatus and methodology for continuous polymer production that allows efficient control of the heat of reaction.

### BRIEF SUMMARY OF SOME OF THE PREFERRED EMBODIMENTS

Disclosed herein is a method for removing heat from a horizontal linear flow reactor, comprising introducing vapor bubbles into a liquid medium in the reactor and removing the vapor from the reactor.

Further disclosed herein is a method of producing an elastomer reinforced polymer comprising autorefrigerating the reactants in a horizontal linear flow reactor in which both initial polymerization and phase inversion occur.

Further disclosed herein is a method of removing heat from a horizontal plug flow reactor comprising aerating the reactants within the reactor, wherein the aeration promotes radial mixing of the reactants but does not substantially promote axial mixing of the reactants.

Further disclosed herein is a horizontal linear flow reactor, comprising a horizontal reaction chamber having one or more mechanical flow facilitators disposed therein and a sparger attached to the bottom of at least a portion of the reaction chamber.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a picture of a linear flow reactor configuration.

FIG. 2 is a graph of the effect of bubbles on hydrodynamics.

FIG. 3 is also a graph of the effect of bubbles on hydrodynamics.

FIG. 4 is a graph of a comparison of impeller types.

FIG. 5 is a graph of residence time.

FIG. 6 is also a graph of residence time.

FIG. 7 is a graph of optimal operating conditions.

FIG. 8 is a graph of viscosity versus conversion.

FIG. 9 is a graph of the effect of viscosity.

FIG. 10 is a graph of bubble influence on hydrodynamics.

### DETAILED DESCRIPTION OF THE PREFERRED EMBODIMENTS

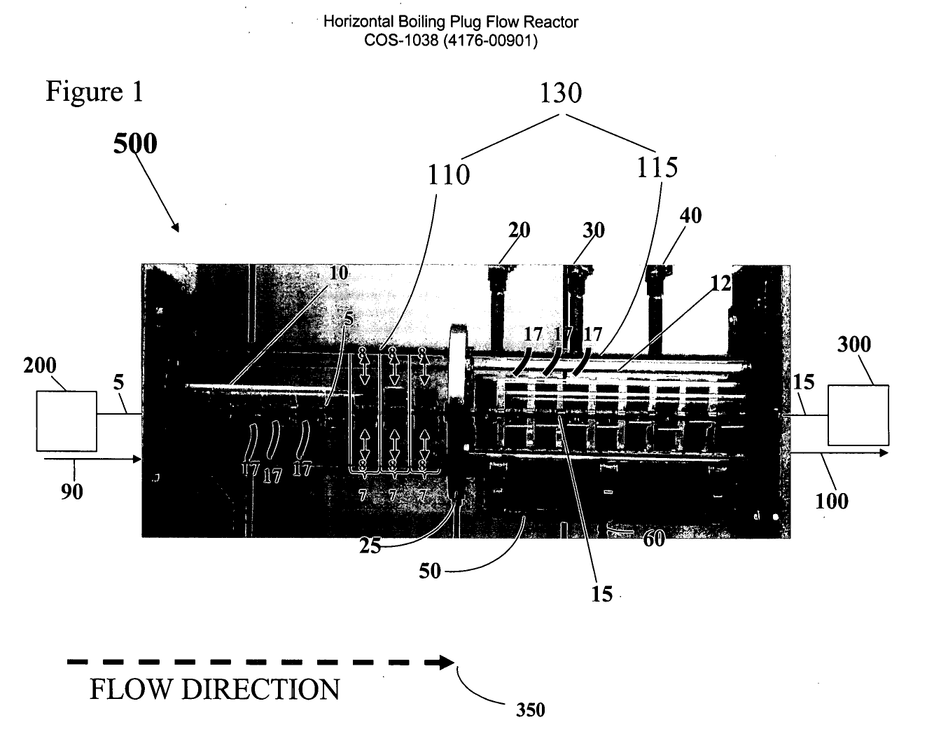

FIG. 1 shows an embodiment of horizontal boiling plug flow reactor (HBPFR) 500 comprising a reaction chamber 130, mechanical flow facilitators 10 and 12 disposed within the reaction chamber 130; driving systems 200 and 300 connected to mechanical flow facilitators 10 and 12, respectively; an optional sparger 50 having a gas inlet port 60 disposed at the bottom of the reaction chamber 130; and gas outlet ports 20, 30 and 40 disposed at the top of the reaction chamber 130. Each driving system 200, 300 may comprise a motor, a transmission case, a torquemeter and a speed encoder (not shown) connected to shafts 5, 15 on the mechanical flow facilitators 10, 12 and driving same. The HBPFR 500 may additionally be equipped with a port for the introduction of a reaction feed stream 90 into the reaction chamber 130 and port for the removal of a product stream 100 from the reaction chamber 130.

In an embodiment, reaction chamber 130, as shown in FIG. 1, is composed of two chambers 110 and 115 connected by collar 25. Alternatively, the reaction chamber 130 may comprise a single chamber or may comprise any number of chambers either connected in series or integrated. In an alternative embodiment, the reaction chamber 130 is a single vessel. Without limitation such reaction chambers may be of cylindrical design however other designs may be employed by one skilled in the art to carry out a substantially equivalent function. The reaction chamber 130 may be constructed from inert materials such as stainless steel.

In the embodiment shown in FIG. 1, the HBPFR may comprise mechanical flow facilitators 10, 12 which increase the mixing of the reactants. Mechanical flow facilitators or devices to mix the reactants are known to one skilled in the art and include instruments such as agitators or blade impellers of various shapes typical of the ones used for the stirring of fluids and multiphase media. In the embodiment depicted in FIG. 1, the mechanical flow facilitators 10, 12 comprise a plurality of blade impellers 17 that may be manually, electrically or hydraulically rotated on one or more rotating shafts 5, 15 driven by motors 200, 300, respectively. In the embodiment depicted in FIG. 1, the impellers in the left reaction chamber 110 are driven by motor 200 via shaft 5 and can be operated independently of the impellers in the right reaction chamber 115 driven by motor 300 via shaft 15. In an alternative embodiment, the impellers are rotated by any number of motors configured to operate in a dependent or independent manner as desired by the user.

The blade impellers 17 correspond to localized flow zones 70. In an embodiment, the blade impellers 17 may be designed with any number of blades evenly spaced about the shaft and configured so as to have substantially no pitch. Such an impeller design would promote the radial flow of the reactants (i.e. flow toward the perimeter of the reactor) as indicated by double arrows 80 within the localized flow zones 80. Blade impellers having no pitch would not interfere with plug flow in the reactor, as such blades do not induce or promote axial mixing of the reactants. In alternative embodiments, the mechanical flow facilitators may comprise other types of impellers that do not disrupt axial flow (i.e., do not substantially disrupt plug flow), for example swept blade impellers or helical ribbon impellers.

Such impellers may be used singly or multiply depending on factors such as the size of the impeller and the size of the HBPFR. In an embodiment, the impeller is comprised of a metal or metal alloy such as stainless steel. Alternatively, the impeller is fabricated from polymer, composite materials, ceramics or glass-lined materials. The choice of fabrication material will depend on the reactants, products and reaction conditions to be employed. The rotation of the blade impellers may be at a rate of from 0.2 m/s to 5 m/s, alternatively, from 1 m/s to 3 m/s. Such conditions as rotation speed may be designed to meet the needs of the user.

In an optional embodiment, vapor or gas bubbles are introduced to the HBPFR via an aeration device such as a sparger 50. The gas may be introduced to the HBPFR specifically to function in heat removal or addition of heat, to incorporate a gas reactant, to modify viscosity, for combinations thereof or for any other reason. Referring to FIG. 1, a sparger 50 in fluid communication with a gas supply through a gas inlet port 60 may allow introduction of a vapor or gas bubbles into reactor chamber 130. A gas may be introduced to the reaction chamber 130 via the sparger 50, which may contain a diffuser or other distributor, flow upward though the reactants in the reaction chamber 130, enter a vapor space in the reaction chamber 130, and be removed through gas outlet ports 20, 30 or 40. In an embodiment, the HBPFR may comprise any number of aeration devices, gas inlet ports and gas outlet ports as necessary for the efficient introduction and removal of vapor or gas bubbles. Such aeration devices, gas inlet and gas outlet ports may be located anywhere along the reaction chamber 130 as necessary to meet the needs of the user. In an embodiment, the sparger, gas inlet and gas outlet ports are located sufficiently downstream of inlet port 90 to allow for the progression of the reaction to a point where the removal of the heat of reaction is desired. In other word, the sparger may be positioned at one or more hot zones within the reactor. Without limitation, gases that may be introduced to the reaction chamber 130 may include air, oxygen or nitrogen or combinations thereof. In an embodiment, the HBPFR may comprise additional devices (not shown) for adjusting the size and or speed of introduction of the gas bubbles into the reaction chamber 130. Such devices are known to one of ordinary skill in the art.

In an embodiment, the HBPFR allows removal of the heat of reaction from the reactor 500 by an autorefrigeration process. Autorefrigeration refers to the in situ formation of vapor or gas bubbles to a liquid reaction medium, which rise upward through the reaction medium and thereby remove the heat of reaction and maintain a substantially constant temperature in the liquid medium. An example of an autorefrigeration process is a solvent-diluent medium being vaporized from a liquid phase in order to remove the exothermic heat of reaction. The vaporized solvent-diluent may be recovered via, for example, a condenser, and the recovered solvent-diluent returned to the reactor. Mechanisms and methods for recovering the vaporized solvent and returning the solvent to the reactor are known to one of ordinary skill in the art. The solvent-diluent may be a single material such as toluene; a constant boiling azeotrope such as benzenecyclohexane, or a reactant in the system.

In an embodiment, autorefrigeration occurs in the HBPFR as the result of the formation of vapor or gas bubbles due to the vaporization of a reaction component from a liquid phase reaction. For example, this may be accomplished by operating the reactor at a pressure, temperature or combination thereof sufficient to induce vaporization of a reaction component. In an embodiment, the reactor may be designed so as to have reaction zones of differing diameters resulting in such zones of differing volumes. Consequently, as the reaction mixture moves through the different reaction zones it may experience changes in the reaction pressure sufficient to allow vaporization of a reaction component. In an alternative embodiment, the reaction chamber 130 is heated to a temperature whereby a given component of the reaction nears or reaches the boiling point for that component. In an embodiment, the reaction component vaporized either through adjustments of the reactor pressure/temperature is the solvent or diluent.

Alternatively, the vapor or gas bubbles are the result of the chemical reaction being carried out in the reactor. For example, the reaction may generate gases such as carbon dioxide, oxygen or hydrogen whose rising under the form of bubbles may also facilitate removal of the heat of reaction.

In an embodiment, the HBPFR functions as a continuous plug flow reactor. The design of the blade impellers 17 makes it possible to eliminate backmixing of the liquid phase without the use of baffles. Alternatively, the HBPFR functions as a continuous plug flow sparging vessel, wherein removal of the heat of reaction is a result of the vapor or gas bubbles introduced by the aeration device as described previously.

The plug flow reactor displays a steady-state fluid flow across the reactor that is characterized by the fact that ideally there must be no mixing or diffusion of elements of the fluid along the flow path (i.e. no axial mixing). Furthermore, a plug flow reactor may be described as one wherein the reaction components experience an equivalent residence time in the reaction zone. Chemical reactions and flow parameters evolution in the PFR can be described by the set of conservation laws equations of chemical hydrodynamics. These equations for steady state conditions in a plug flow reactor can be considered for an idealized system (e.g., a gas phase reaction) by being written in the following form:

### Mass Conservation Equation

$$\frac{ⅆ}{ⅆ x} ( ρ \cdot u \cdot s ) = 0 \qquad ( 1 )$$

### Momentum Conservation Law

$$u \cdot \frac{ⅆ u}{ⅆ x} = - \frac{1}{ρ} \cdot \frac{ⅆ P}{ⅆ x} \qquad ( 2 )$$

### Energy Conservation Law

$$ρ \cdot u \frac{ⅆ}{ⅆ x} ( {\sum }_{1} {h}_{i} \cdot {Y}_{i} + \frac{{u}^{2}}{2} ) = Q \qquad ( 3 )$$

### Mass Conservation Equations for Each Component

$$u \cdot \frac{ⅆ {Y}_{i}}{ⅆ x} = \frac{{W}_{i}}{ρ} \qquad ( 4 )$$

where r, u, s, P—density, velocity, cross sectional area and pressure of the gas flow respectively; Yᵢ=ρ₂¹ρ mass fraction of component i; Wᵢ—chemical production rate of the i-th component; Q-volume density of the external heat sources. Total enthalpy of each component hᵢ can be written in the form:

$${h}_{i} = {h}_{i}^{o} + {\int }_{{T}_{0}}^{T} {C}_{pi} \cdot ⅆ T \qquad ( 5 )$$

where T—gas temperature; hᵢ⁰—creation enthalpy of the i-th—component at the reference temperature; Cₚᵢ—thermal capacity at a constant pressure.
The system (1)-(4) must be added by ideal gas law:

$$P = ρ \cdot R \cdot T \cdot {\sum }_{i = 1}^{n} \frac{{Y}_{i}}{{μ}_{i}} \qquad ( 6 )$$

where R—gas constant, m_{I}—molecular weight of component I, n—number of components. Total chemical reaction rate for each component can be written in the following form:

$$Wi = {\sum }_{j = 1}^{i - {M}_{i}} {ξ}_{j}^{i} \cdot {k}_{j}^{i} \cdot {\prod }_{k - 1}^{k - {B}_{j}} \frac{ρ}{{μ}_{k}} \cdot {N}_{a} \cdot {Y}_{k} \qquad ( 7 )$$

where Mᵢ—number of chemical reactions which effect the concentration of the component i; ζⁱⱼ number of the molecules generated or eliminated in the reaction i; kⁱⱼ—rate coefficient of chemical reaction j; Bⁱⱼ number of components which take part in the reaction j for component i. Nₐ—Avagadro number.

In a general system equations (1)-(4), (6) for the given chemical mechanism, external heat sources, density or heating and quenching rates, initial gas parameters and composition allows the shape of concentrations, temperature, velocity gas density profiles within a plug flow reactor to be calculated.

Referring again to FIG. 1, the reaction chamber 130 may be designed so as to establish plug flow behavior across localized flow zones 70. In these flow zones the reactants are subjected to substantially uniform radial mixing as indicated generally by arrows 80 as they are dispersed between the impeller shaft and the reaction chamber walls. A displacement motive force is generated by the introduction of a reactant stream via inlet port 90 and removal of a product stream via outlet port 100 promoting axial flow of the mixture through the reaction chamber 130 as indicated by the flow direction arrow 350.

The HBPFR disclosed herein may function as a chemical reactor singularly or may be serially connected to any number of additional reactors, that may be the same or different. In an embodiment, the HBPFR disclosed herein is used singularly or as part of an apparatus with any number of serially connected like-reactors to carry out any chemical reaction compatible with the features of the HBPFR. Alternatively, the HBPFR functions as a plug flow reactor in a polymerization process.

In an embodiment, the HBPFR is used as a plug flow reactor in the production of high impact polystyrene (HIPS). HIPS preparation involves the dissolution of an elastomer such as polybutadiene rubber in styrene that is subsequently polymerized. During polymerization, a phase separation based on the immiscibility of polystyrene and polybutadiene occurs in two stages. Initially, the polybutadiene forms the major or continuous phase with styrene dispersed therein. However, as the reaction progresses and the amount of polystyrene continues to increase a morphological transformation or phase inversion occurs such that the polystyrene now forms the continuous phase. This phase inversion leads to the formation of complex rubbery particles in which the rubber exists in the form of membranes surrounding occluded domains of polystyrene.

A reaction mixture for the production of HIPS may comprise from about 75% to about 99% styrene, from about 1% to about 15% polybutadiene, from about 0.001% to about 0.2% free radical initiator and additional components as needed to impart the desired physical properties. The percent values given are percentages by weight of the total composition.

In an embodiment, the HBPFR is part of a conventional apparatus and process configuration for the production of HIPS. Conventional process configurations and apparatuses for the production of HIPS are known to one of ordinary skill in the art. Alternatively, the HBPFR is operated as a plug flow inversion reactor (PFIR). In such an embodiment, the HBPFR is operated under conditions wherein a reactant feed stream is introduced to the HBPFR and then the HIPS polymerization reaction is allowed to proceed to at least the point of phase inversion before the reaction mixture is introduced to any additional polymerization reactors. In an embodiment, both initial polymerization and phase inversion occur in the HBPFR.

The HIPS produced by the disclosed methodologies may be useful for a range of applications including; food packaging, office supplies, point-of-purchase signs and displays, housewares and consumer goods, building insulation and cosmetics packaging.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Experimental Procedure

A design for a HBPFR that has operated successfully as a cold sparged rig is disclosed in FIG. 1. More specifically, a lab scale HBPFR as shown in FIG. 1 was built having two chambers 110 and 115 that were 6 inches in diameter and 18 inches long. The ability of the cold sparged rig to perform as a PFR was evaluated in Examples 1 through 4. The reactor has a system of aeration, the sparger, 50, which generates small bubbles. The sparger 50 was positioned in an external box (not shown) and is included inside the bottom sidewall of the reactor chamber. It is a metal perforated sheet wrapped with 20 μm polypropylene filter bags as a diffuser to get small bubbles with a departure speed close to zero. The reactor is provided with a series of agitators operating between 10 and 200 RPM.

All of the following experiments were conducted using a glucose tracer solution to simulate a reaction mixture. Glucose was chosen to simulate the components of a reaction mixture (e.g., a polymerization mixture) for its ability to be easily used at several viscosities. In typical polymerization processes, viscosity varies along the PFR, as it depends on the rate of polymerization. The viscosity is also function of the characteristics of the initial mixture (type of elastomer, initial concentration of elastomer in styrene, concentration of initiators . . . ) and the process conditions (temperature, shear rates, type of polymerization . . . ). The Residence Time Distribution of the reactor was obtained by conductivity measurements using an ionic tracer with physical properties similar to those of the reactor solution. The tracer was composed of chlorohydric acid (10 M) added to pure glucose (80% mass percent of glucose). This tracer solution makes it possible to obtain a correct detection by the conductivity cells, however its mean viscosity is not the same than the one of the reactor solution: 0.3 Pa·s. This could have had an influence on the dispersion of the tracer, in particular for the experiments at high viscosities for which the difference of viscosity between the tracer and the whole reactor solution can reach 1.7 Pa·s.

The same quantity of tracer was injected for every experiment, and the outlet signal obtained was transformed to be dimensionless. Thus curves are comparable. Hydrodynamics in the reactor was investigated visually. The visual tracer was composed of glucose with caustic soda (10 M, 20% mass), which gives glucose a brown color. Injections of a visual tracer make it also possible to neutralize the reactor solution after a RTD experiment.

### Example 1

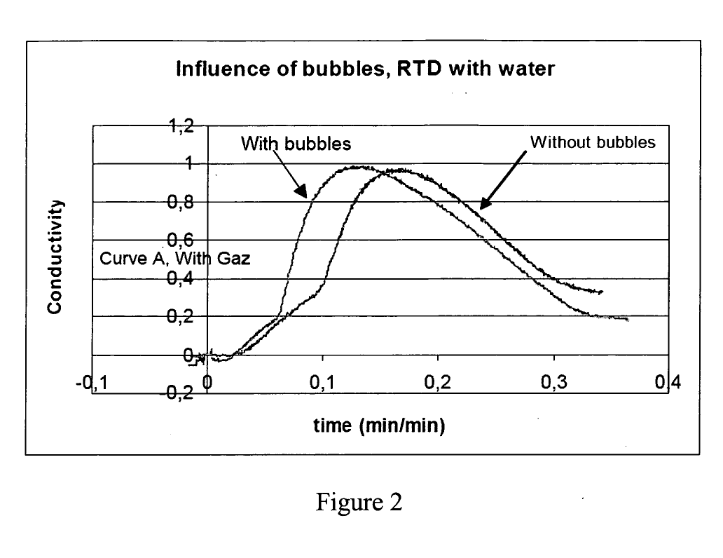

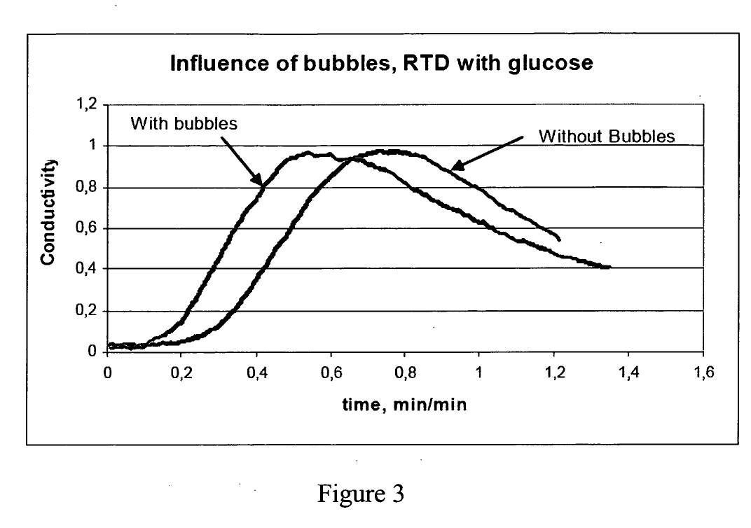

The influence of the addition of bubbles through the sparging device on the PFR behavior of the HBPFR was determined. Bubbles were found to decrease the mean residence time (RT) for the two viscosities compared. A difference of 2 minutes is observed in the case of water and a difference of 9 minutes in the case of glucose at 2 Pa·s, FIGS. 2 and 3. Concerning the axial dispersion, a significant increase can be noticed for water experiments with bubbles. For experiments at 2 Pa·s, the axial dispersion is similar for the two curves.

The results of these experiments indicate that in the heterogeneous flow (bubble size distribution), the dispersion coefficient increases in a significant way with the superficial gas velocity. Thus bubbles favor the dispersion mechanism. This result was verified with experiments performed with water. However, for viscosities around 2 Pa·s, bubbles do not induce more axial dispersion to a significant degree. Moreover, bubbles boost the fluid progression in the reactor for the two viscosities. This can be attributed to a turbulent mechanism: bubbles create eddies, and fluid transport is realized between eddies.

Finally, bubbles also induce radial mixing. Indeed, a part of the liquid moves in the bubble wakes at the same velocity as the bubbles, which follow a convective flow. This liquid bubble wake may detach and pass to the bulk liquid surrounding it and, in this way, contributes to radial mixing.

### Example 2

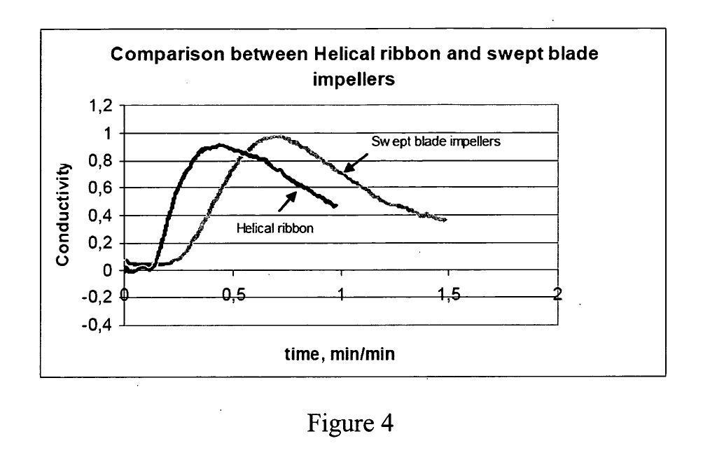

The influence of the mechanical flow facilitator on the PFR behavior of the HBPFR was determined. Two types of impeller were tested for the aerated part: the helical ribbon and the swept blade impellers. The non aerated part was equipped with swept blade impellers. FIG. 4 compares the RTD obtained with the two types of impeller: The results indicate that the fluid progression in the reactor is faster with the helical ribbon as shown by a difference of 12 minutes on the mean RT is observed, see FIG. 4. Concerning the axial dispersion, the two curves do not show significant differences. In order to reach the targeted RT, swept blade impellers for the aerated part were also advised.

### Example 3

The influence of the rotating speed of the impellers on the PFR behavior of the reactor was determined. The rotating speed in the non-aerated part did not influence the axial dispersion to a significant degree. The mean RT (around 31 minutes) also remained about the same.

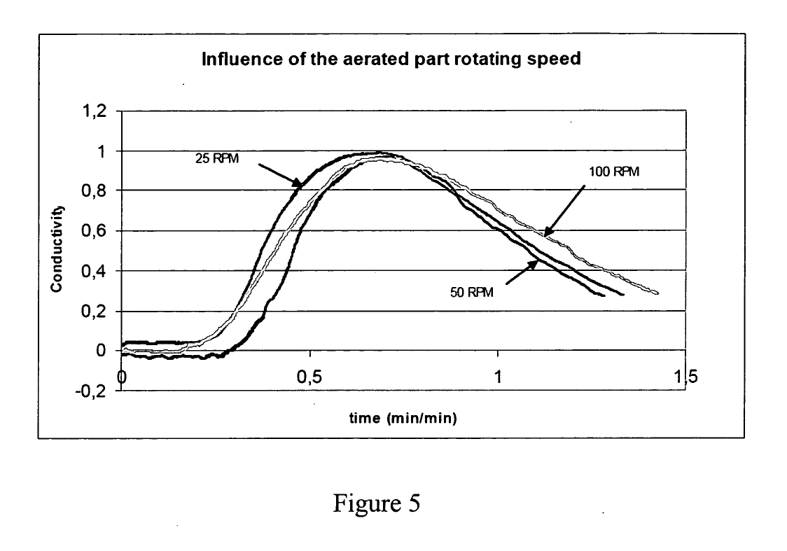

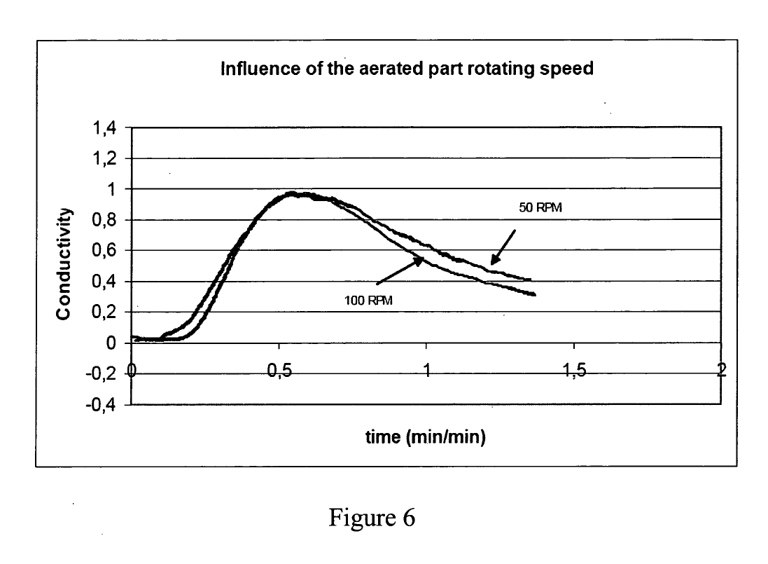

However, the rotating speed of the impellers did affect the RT in the aerated part of the reactor. The comparison of the curves at 25 and 50 RPM highlights that an increase in the aerated part rotating speed leads to a significant decrease in the axial dispersion, FIG. 5. However, comparison of the curves at 50 RPM and 100 RPM gives the opposite result: axial dispersion was definitely more important for the experiment at 100 RPM than at 50 RPM. The mean RT was about identical for the three curves. There is thus an optimal value for the aerated part rotating speed which minimizes axial dispersion. This value is approximately at 50 RPM. However, according to FIG. 6, this optimal value depends on the non aerated part rotating speed: by fixing the rotating speed of the non aerated part at 50 RPM, the axial dispersion is more important for the curve at 50 RPM than for the one at 100 RPM.

Therefore, hydrodynamics in the aerated part of the reactor seems to be linked to the movement in the non aerated part. A tradeoff was found between the value of the rotating speed of each part of the reactor and AN, the difference of rotating speed between the two parts.

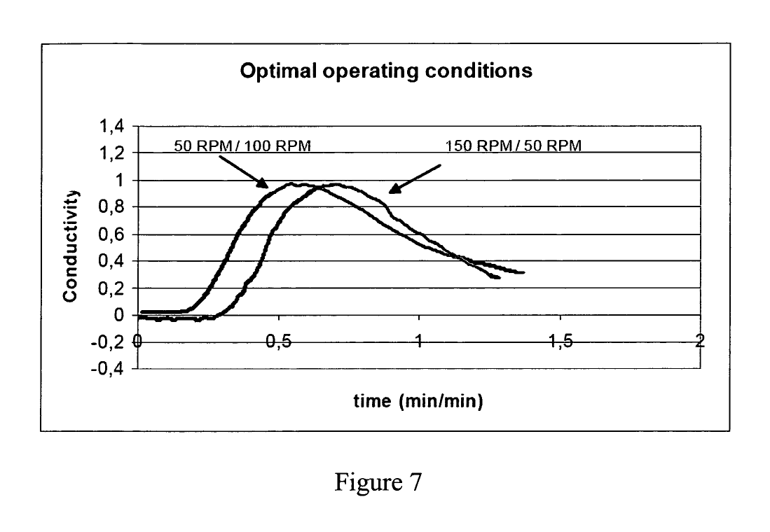

Referring to FIG. 7, the following operating conditions: 150 RPM for the non aerated part, 50 RPM for the aerated part, gave the best plug flow trend (minimal dispersion) and the longest mean RT (around 33 minutes) for the configuration with 6 swept blade impellers.

### Example 4

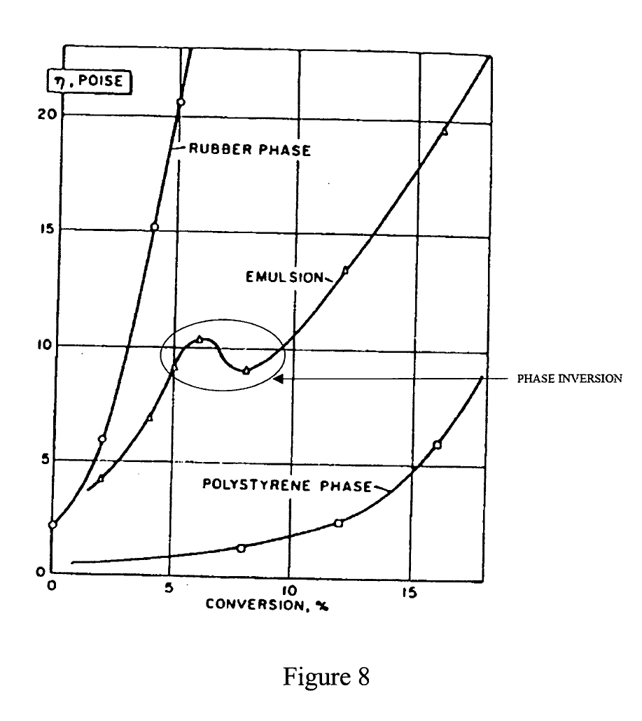

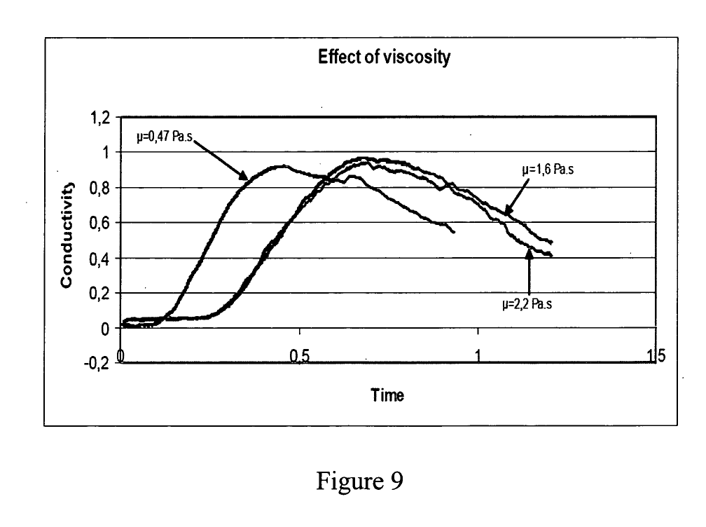

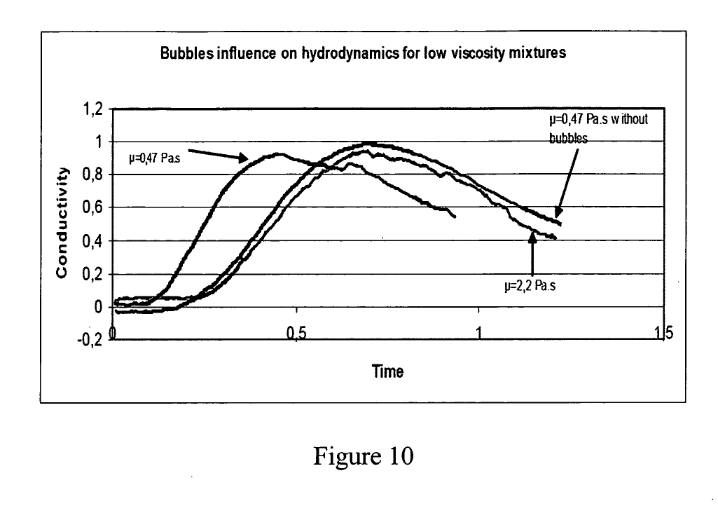

According to FIG. 8, viscosity in the process of HIPS production is globally comprised between 0.5 and 2.5 Pa·s. Hydrodynamics in the cold rig was thus studied for this viscosity range. Experiments were performed with the optimal operating conditions determined in Experiment 4. Viscosity measurements were carried out at the temperature of the reactor (around 22.3° C.). The value indicated on FIG. 9 for each curve is the average of the values obtained at different shear rates. As glucose behaves like a Newtonian fluid, viscosities measured experimentally vary minimally with shear rate. According to FIG. 9, for viscosities equal to or greater than 1.6 Pa·s, the effect of viscosity on axial dispersion and mean RT is negligible. However, for viscosities around 0.5 Pa·s, a significant increase in the axial dispersion and a decrease of 11 minutes in the mean RT can be noticed. In order to determine the role of bubbles in hydrodynamics for viscosities around 0.5 Pa·s, an experiment at 0.5 Pa·s without bubbles was performed. The RDT obtained is given FIG. 10. According to FIG. 10, the RTD is similar with the one obtained at 2.2 Pa·s with bubbles. Thus, the increase in the axial dispersion observed for viscosities around 0.5 Pa·s is mostly due to the presence of bubbles. For viscosities around 0.5 Pa·s, the presence of bubbles leads to a large impact on RTD curve attitude whereas for mixtures around 2 Pa·s, bubbles do not affect in a significant way the axial dispersion.

In the production of HIPS, before the phase inversion, the viscosity of the mixture is between 0.5 and 1 Pa·s. The evaporation of the solvent begins after the phase inversion. As there are no bubbles, for that range of viscosity a plug flow trend should be obtained before the evaporation, according to FIG. 10. When the first bubbles appear, the viscosity of the mixture is higher than 1 Pa·s and increase rapidly to reach 2 Pa·s. Therefore, it is likely that the effect of bubbles on axial dispersion during evaporation is negligible, according to FIG. 3. To conclude, although the viscosity in the real process varies from 0.5 Pa·s to 2.5 Pa·s, it is highly probable that the presence of bubbles does not affect the plug flow trend. One can expect that the RTD obtained by using glucose at 2 Pa·s is close to the one obtained with the real mixture

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method for removing heat from a horizontal linear flow reactor, comprising introducing vapor bubbles into a liquid medium in the reactor and removing the vapor from the reactor.

2. The method of claim 1 wherein the liquid medium comprises a vinylmonomer, a dissolved elastomer and a free radical initiator.

3. The method of claim 1 wherein the horizontal linear flow reactor is a plug flow reactor.

4. The method of claim 1 further comprising a mechanical flow facilitator disposed therein.

5. The method of claim 4 wherein the mechanical flow facilitator is an impeller, an agitator or combinations thereof that induces radial mixing and limits backmixing.

6. The method of claim 1 wherein the vapor bubbles are formed in situ within the reactor by a pressure differential.

7. The method of claim 1 wherein the vapor bubbles are formed in situ within the reactor via a chemical reaction.

8. The method of claim 1 wherein the vapor bubbles are introduced by a sparging device coupled to the reactor.

9. The method of claim 8 wherein the sparging device introduces air, oxygen, carbon dioxide, hydrogen, nitrogen, an inert gas or combinations thereof.

10. The method of claim 8 further comprising a method for controlling the size and speed of the gas bubbles or vapor phase introduced.

11. The method of claim 1 wherein the vapor phase is formed by heating a reaction component of the liquid medium.

12. The method of claim 11 wherein the reaction component is the solvent or diluent.

13. The method of claim 1 further comprising recycling the vaporized component to the reactor.

14. A method of producing an elastomer reinforced polymer comprising autorefrigerating the reactants in a horizontal linear flow reactor in which both initial polymerization and phase inversion occur.

15. The method of claim 14 wherein the reaction mixture comprises at least one vinylmonomer, an elastomer, and a free radical initiator.

16. The method of claim 15 wherein the vinylmonomer is a styrene, a substituted styrene, an unsubstituted styrene or combinations thereof.

17. The method of claim 15 wherein the elastomer is a polymer of butadiene.

18. The method of claim 14 wherein the horizontal linear flow reactor is a plug flow reactor, a continuous plug flow sparging vessel, or combinations thereof.

19. A method of removing heat from a horizontal plug flow reactor comprising aerating the reactants within the reactor, wherein the aeration promotes radial mixing of the reactants but does not substantially promote axial mixing of the reactants.

20. A horizontal linear flow reactor, comprising a horizontal reaction chamber having one or more mechanical flow facilitators disposed therein and a sparger attached to the bottom of at least a portion of the reaction chamber.
